(19) United States
(12) Patent Application Publication
(10) Pub. No.: US 2004/0240749 A1
(43) Pub. Date: Dec. 2, 2004

(54) Image processing device, image processing method, and program

(75) Inventors: Shinji Miwa, Nirasaki-shi (JP); Naoki Kayahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/812,051

(22) Filed: Mar. 30, 2004

(30) Foreign Application Priority Data
Mar. 31, 2003 (JP) 2003-097065
Feb. 5, 2004 (JP) 2004-029439

(51) Int. Cl. G06K 9/46; G06K 9/34

(52) U.S. Cl. 382/274; 382/173

(57) ABSTRACT

The invention provides an image processing device, an image processing method, and a program with which the color of a reproduced image that is reproduced based on the corrected pixel information can be brought close to the memorized color by correcting the pixel information of the pixels constituting an image region based on the region characteristics of this image region for each image region obtained by segmenting the target region. The image processing device of the invention can include a region segmentation device for segmenting a target image composed of a plurality of pixels into a plurality of image object regions by employing as boundaries the portions where characteristics between the pixels change, and an image correction device for correcting the pixel information of the pixels constituting the image object region based on region characteristic information indicating a representative characteristic of the image object region, for each image object region segmented by the region segmentation device.

### BACKGROUND OF THE INVENTION

1. Field of Invention

The present invention relates to an image processing device, an image processing method, and a program. In particular, the present invention relates to an image processing device, an image processing method, and a program increasing the visual effect with respect to digital data of photographic images that are input with a digital still camera or a scanner.

2. Description of Related Art

Generally, colors that people memorize are most often remembered as a color which is brighter than the color that was actually viewed. For example, people memorize colors of sunset, blue sky, and tree leaves as a vivid color than they actually are. Such colors that people memorize are called memorized colors. Therefore, when image information is saved as a photo, digital data, or the like, and the saved digital data or the like are reproduced, for example, with a display device or printing device, if the observer compares the colors of the reproduced image that faithfully reproduces the digital data of the saved original image and the memorized colors which are in the observer's memory, the brightness of the reproduced image most often seems to be insufficient. For this reason a variety of methods for image correction processing for bringing the colors of the reproduced image close to the memorized colors have been suggested.

For example, JP-A-9-326941 suggests a method for matching a reference color that was set in advance and a representative value (for example, a mean value or a central value) of color data in the vicinity of the reference color which is contained in the image. Further, JP-A-2000-123164 suggests a method comprising segmenting an image into fixed-shape regions and conducting saturation conversion according to the objects in each segmented region. Furthermore, JP-A-2001-92956 suggests a method for correcting only the region of specific physical object selected by a recording operator so that this physical object matches the distributable region of the color of this physical object stored in a database. Further, JP-A-2002-279416 suggests a method by which a shape (for example, a face or a road) with a memorized color is recognized, without using color information, from within the image and the image color of this region is replaced with a “the color which the physical object of the sharp should be.”

However, the above-described inventions related to methods for conducting color tone correction according to the preset reference color or shape, the correction was conducted to a typical color of the physical object of this reference color or shape, and this color sometimes did not match the memorized color that was memorized by the observer for a specific scene. Furthermore, there were also cases in which the photography plans were frustrated, for example, the photo intentionally taken under an incandescent light illumination was converted so that it looked taken under the white light.

The drawback of the invention of JP-A-2001-92956 was that the operation of selecting a physical object by an operator was necessary, and when a multiplicity of images were processed, the operations became complex. The increased work cost was also a problem.

Furthermore, the drawback of the invention of the JP-A-2000-123164 was that saturation conversion was conducted by selecting parameters based on image characteristics, but if the saturation conversion parameters were selected according to the main target of the image, the background color could not be corrected to the adequate color.

### SUMMARY OF THE INVENTION

The invention was created in view of the above-described problems, and it is an object of the invention to provide an image processing device, an image processing method, and a program with which the color of a reproduced image that is reproduced based on the corrected pixel information can be brought close to the memorized color by correcting the pixel information of the pixels constituting an image region based on the region characteristic of this image region for each image region obtained by segmenting the target region.

In order to resolve the above-described problems, an image processing device of invention can be characterized in that it can include a region segmentation device for segmenting a target image composed of a plurality of pixels into a plurality of image object regions by employing, as boundaries, the portions where characteristics between the pixels change, and an image correction device for correcting the pixel information of the pixels constituting the image object region based on region characteristic information indicating a representative characteristic of the image object region, for each of the image object region segmented by the region segmentation device.

With the region segmentation device, the target region is segmented into a plurality of image object regions, and with the image correction device, the pixel information of the pixels constituting the image object region is corrected based on the region characteristic for each segmented image object region, so that the color of the reproduced image is brought close to the memorized color.

As a result, because a comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The region characteristic as referred to in the present invention indicates a quantitative value, such as a statistical value (mean, dispersion, standard deviation, and the like) of pixel values or finesse (spatial frequency characteristic) of the image and does not include qualitative characteristics such as a size (surface area) or shape of the region (the same is true for the below-described image processing device and image processing program).

Further, the pixel information can mean information including, e.g., pixel position in the target image in addition to the pixel values such as the below-described RGB values or CMYK values (the same is true for the below-described image processing device and image processing program).

The image processing device of the invention can also be characterized in that it can include a region segmentation device for segmenting a target image composed of a plurality of pixels into a plurality of image object regions and image correction means for correcting the pixel information of the pixels constituting the image object region based on region characteristic information indicating a characteristic of the image object region, for each of the image object region segmented by the region segmentation device.

As a result, similarly to above-described invention, because comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing device of invention can be characterized in that, in the image processing device described above, the image correction device includes a region characteristic calculation device for calculating the region characteristic information of the image object region based on the pixel information of the pixels constituting the image object region, a correction function setting device for setting a correction function for correcting the pixel information of the pixels constituting the image object region based on the region characteristic information of the image object region calculated by the region characteristic calculation device, and a pixel information correction device for correcting the pixel information of the pixels constituting the image object region based on the correction function that was set by the correction function setting device.

With the region characteristic calculation device, region characteristics of the image object region are calculated based on the pixel information of the pixels constituting the image object region. For example, the mean value of characteristics of all the pixels of the image object region is calculated as the region characteristic of the image object region, or the maximum value of the characteristics of the pixels of the image object region is calculated as the region characteristic of the image object region. Furthermore, with the correction function setting device, a correction function is set for correcting the pixel information of the pixels of the image object region, and with the pixel information correction device, the pixel information of the pixels constituting the image object region is corrected based on the correction function.

As a result, because comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing device of invention can be characterized in that, in the image processing device described above, it can include a region characteristic calculation device for calculating the region characteristic information of the image object region based on the pixel information of the pixels constituting the image object region, and a correction function setting device for setting a correction function for correcting the pixel information of the pixels constituting the image object region based on the region characteristic information of the image object region calculated by the region characteristic calculation device. The pixel information correction device can include a pixel information correction device for correcting the pixel information of the pixels constituting the image object region based on the correction function that was set by the correction function setting device.

As a result, similarly to above invention, because comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing device of invention can also be characterized in that, in the image processing device described above, the correction function and application conditions that defined a plurality of the region characteristic information conditions are mapped and the correction function setting means retrieves the correction function corresponding to the application conditions that satisfy the region characteristic information from a plurality of the correction functions based on the region characteristic information of the image object region.

Because the correction function for correcting the pixel information of the pixels constituting the image object region is automatically retrieved based on the region characteristic of the image object region, the complex operation of selecting the image object region which is desired to be corrected by the operator and correcting the selected image object region is avoided and the work cost is reduced.

The image processing device of invention can be characterized in that, in the image processing device described above, the correction function setting device retrieves the application conditions that satisfy the region characteristic information of the image object region based on a correction function table comprising a plurality of sets of the application conditions and the correction functions and retrieves the correction function constituting the set with the retrieved application conditions.

Because the correction function for correcting the pixel information of the pixels constituting the image object region is automatically retrieved based on the region characteristic of the image object region and the correction function table, the complex operation of selecting the image object region which is desired to be corrected by the operator and correcting the selected image object region is avoided and the work cost is reduced.

The image processing device can be characterized in that, in the image processing device described above, the correction function setting device retrieves the application conditions to which the region characteristic information of the image object region corresponds, based on a correction function table mapping and registering a plurality of application conditions and correction functions and retrieves the correction function corresponding to the retrieved application conditions.

As a result, similarly to above-described invention, because the correction function for correcting the pixel information of the pixels constituting the image object region is automatically retrieved based on the region characteristic of the image object region and the correction function table, the complex operation of selecting the image object region which is desired to be corrected by the operator and correcting the selected image object region is avoided and the work cost is reduced.

The image processing device can also be characterized in that, in the image processing device of the above invention, the correction function setting device sets any one of the correction function table of a plurality of the different correction function tables with respect to one or a plurality of the image object regions and sets the correction function for correcting the pixel information of the pixels constituting the image object region based on the region characteristic information of the image object region and the correction function table that was thus set.

The operator can select the appropriate correction function table from a plurality of correction function tables for each image object region or target image by using an input device or the like. As a result, an adequate image correction can be conducted for each image object region. Therefore, it is possible to generate a reproduced image in which the color of the physical object has been corrected to the color close to the memorized color by considering the physical object that left an impression as one image object region. For example, when “person”, “passionately”, etc., combinations are prepared and the “person” combination is used, the saturation as a whole can be dropped and a correction can be made to a soft color tone, and when the “passionately” combination is used, the correction can be made so as to emphasize the color of the red system.

The image processing device can be characterized in that, in the image processing device described above, the correction function setting device sets any one of the correction function table of a plurality of the different correction function tables with respect to one or a plurality of the image object regions and sets the correction function for correcting the pixel information of the pixels constituting the image object region based on the region characteristic information of the image object region and the correction function table that was thus set.

As a result, similarly to the above invention, an adequate image correction can be conducted for each image object region. Therefore, it is possible to generate a reproduced image in which the color of the physical object has been corrected to the color close to the memorized color by considering the physical object that left an impression as one image object region.

The image processing device can also be characterized in that, in the image processing device described above, the region segmentation device can include a boundary region detection device for detecting, based on prescribed region recognition conditions, as a boundary region, the pixel group which is the pixel group present on the boundary of the two adjacent image object regions and in the vicinity thereof and is composed of the pixels having characteristics intermediate between the respective characteristics of the two image object regions.

With the boundary region detection device, the boundary region sandwiched between two image object regions and composed of pixels having characteristics intermediate between the respective characteristics of the two image object regions is detected as one image region. As a result, even when the image object located in the target image is not marked off by clear edges and produces a boundary region of a certain width, this boundary region can be segmented as an image region and an adequate image correction can be conducted with respect to this boundary region.

The image processing device can also be characterized in that, in the image processing device described above, the region segmentation device can include a boundary region detection device for detecting, based on prescribed region recognition conditions, as a boundary region of a first image object region, and a second image object region A boundary pixel group sandwiched by a first pixel group composed of pixels having characteristics of the first image object region and a second pixel group composed of pixels having characteristics of the second image object region, where one image object region of the adjacent image object regions is considered as the first image object region and the other image object region is considered as the second image object region. As a result, similarly to the above invention, even when the image object located in the target image is not marked off by clear edges and produces a boundary region of a certain width, this boundary region can be segmented as an image region and an adequate image correction can be conducted with respect to this boundary region.

The image processing device can be characterized in that, in the image processing device of the above-described invention, the correction function setting device corrects the pixel information of the pixels constituting the boundary region based on a first correction function which is the correction function set by the region characteristic information of the first image object region and a second correction function which is the correction function set by the region characteristic information of the second image object region, where the first image object region and second image object region are the two image object regions sandwiching the boundary region. Correcting pixel information of pixels in the boundary region based on the correction function for correcting the respective region of the two image object regions sandwiching the boundary region makes it possible to generate a reproduced image without a sense of discomfort and without losing the continuity of the image corrected for each image object region sandwiching the boundary region.

An image processing method of the invention can be characterized in that it includes a region segmentation step of segmenting a target image composed of a plurality of pixels into a plurality of image object regions by employing, as boundaries, the portions where characteristics between the pixels change and an image correction step of correcting the pixel information of the pixels constituting the image object region based on region characteristic information indicating a representative characteristic of the image object region, for each of the image object region segmented in the region segmentation step.

As a result, because a comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing method of invention can be characterized in that, in the image processing method described above, the image correction step can include a region characteristic calculation step of calculating the region characteristic information of the image object region based on the pixel information of the pixels constituting the image object region, a correction function setting step of setting a correction function for correcting the pixel information of the pixels constituting the image object region based on the region characteristic information of the image object region calculated in the region characteristic calculation step, and a pixel information correction step for correcting the pixel information of the pixels constituting the image object region based on the correction function that was set in the correction function setting step.

As a result, because a comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing method of invention can be characterized in that, in the image processing method described above, it includes a region characteristic calculation step of calculating the region characteristic information of the image object region based on the pixel information of the pixels constituting the image object region and a correction function setting step of setting a correction function for correcting the pixel information of the pixels constituting the image object region based on the region characteristic information of the image object region calculated in the region characteristic calculation step. The image correction step can include a pixel information correction step of correcting the pixel information of the pixels constituting the image object region based on the correction function that was set in the correction function setting step.

As a result, similarly to above invention, because a comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

The image processing method of the invention can be characterized in that, in the image processing method described above, the correction function setting step can include mapping the correction function with application conditions that defined a plurality of the region characteristic information conditions and retrieving the correction function corresponding to the application conditions that satisfy the region characteristic information from a plurality of the correction functions based on the region characteristic information of the image object region. As a result, similarly to the above invention, because the correction function for correcting the pixel information of the pixels constituting the image object region is automatically retrieved based on the region characteristic of the image object region, the complex operation of selecting the image object region which is desired to be corrected by the operator and correcting the selected image object region is avoided and the work cost is reduced.

The image processing method can be characterized in that, in the image processing method of the above-described invention, the correction function setting step can include retrieving the application conditions that are satisfied by the region characteristic information of the image object region based on a correction function table mapping and registering a plurality of application conditions and correction functions, and retrieving the correction function corresponding to the retrieved application conditions. As a result, similarly to the above-described invention, because the correction function for correcting the pixel information of the pixels constituting the image object region is automatically retrieved based on the region characteristic of the image object region and the correction function table, the complex operation of selecting the image object region which is desired to be corrected by the operator and correcting the selected image object region is avoided and the work cost is reduced.

The image processing method of invention can also be characterized in that, in the image processing method of the above invention, the correction function setting step can include setting any one of the correction function table of a plurality of the different correction function tables with respect to one or a plurality of the image object regions and setting the correction function for correcting the pixel information of the pixels constituting the image object region based on the region characteristic information of the image object region and the correction function table that was thus set. As a result, similarly to the above invention, because an adequate image correction can be conducted for each image object region, a reproduced image in which the color of the physical object has been corrected to the color close to the memorized color can be generated by considering the physical object that left an impression as one image object region.

The image processing method of invention can be characterized in that in the image processing method of any one invention of the above-described inventions, the region segmentation step can include a boundary region detection step of detecting, based on prescribed region recognition conditions, as a boundary region, the pixel group which is the pixel group present on the boundary of the two adjacent image object regions and in the vicinity thereof and is composed of the pixels having characteristics intermediate between the respective characteristics of the two image object regions. As a result, even when the image object located in the target image is not marked off by clear edges and produces a boundary region of a certain width, this boundary region can be segmented as an image region and an adequate image correction can be conducted with respect to this boundary region.

The image processing method of invention can further be characterized in that, in the image processing method of invention, the correction function setting step can include correcting the pixel information of the pixels constituting the boundary region based on a first correction function which is the correction function set by the region characteristic information of the first image object region and a second correction function which is the correction function set by the region characteristic information of the second image object region, where the first image object region and second image object region are the two image object regions sandwiching the boundary region. As a result, similarly to the above invention, correcting pixel information of pixels in a boundary region based on the correction function for correcting the respective region of the two image object regions sandwiching the boundary region makes it possible to generate a reproduced image without a sense of discomfort and without losing the continuity of the image corrected for each image object region sandwiching the boundary region. Furthermore, because a general-purpose computer such as a personal computer (PC) can be directly used, the implementation is easier and more cost effective than in the case of implementation by constructing special hardware. Further, the improvement of the functions of the method can be easily realized by modifying part of the program.

An image processing program of invention can be a program for executing with a computer the steps of an image processing method. The steps can include a region segmentation step of segmenting a target image composed of a plurality of pixels into a plurality of image object regions by employing, as boundaries, the portions where characteristics between the pixels change larger than a prescribed threshold, and an image correction step of correcting the pixel information of the pixels constituting the image object region based on region characteristic information indicating a representative characteristic of the image object region, for each of the image object region segmented in the region segmentation step. As a result, because comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

An image processing program of invention can be a program for executing with a computer the following steps included in the above image correction step of the image processing method of above invention. The steps can include a region characteristic calculation step of calculating the region characteristic information of the image object region based on the pixel information of the pixels constituting the image object region, a correction function setting step of setting a correction function for correcting the pixel information of the pixels constituting the image object region based on the region characteristic information of the image object region calculated in the region characteristic calculation step, a pixel information correction step of correcting the pixel information of the pixels constituting the image object region based on the correction function that was set in the correction function setting step.

As a result, because comparatively adequate image correction can be conducted for each image object region, selecting a physical object that left an impression as one image object region makes it possible to generate a reproduced image in which the physical object color was corrected to a color close to a memorized color. Furthermore, because a comparatively adequate image correction of the background as one region is also possible, image correction can be conducted without being affected by the color of the physical object that left an impression. Moreover, because image correction is executed automatically without the selection of image object region by the operator, the complexity of operations is avoided and the work cost is reduced.

An image processing program described above can be a program for executing with a computer the following step included in the region segmentation step of the image processing above-described method. The step can include a boundary region detection step of detecting, based on prescribed region recognition conditions, as a boundary region the pixel group which is the pixel group present on the boundary of the two adjacent image object regions and in the vicinity thereof and is composed of the pixels having characteristics intermediate between the respective characteristics of the two image object regions. As a result, even when the image object located in the target image is not marked off by clear edges and produces a boundary region of a certain width, this boundary region can be segmented as an image region and an adequate image correction can be conducted with respect to this boundary region.

### BRIEF DESCRIPTION OF THE DRAWINGS

The invention will be described with reference to the accompanying drawings, wherein like numerals reference like elements, and wherein:

FIG. 1 is a structural diagram of an image processing device;

FIG. 2 is an example of a functional block diagram of an image processing device;

FIG. 3 is a schematic diagram illustrating a three row by three column pixel bitmap data;

FIG. 4 is a schematic diagram for explaining the first pixel group, second pixel group, and boundary pixel group;

FIG. 5 is a schematic drawing illustrating characteristics of image regions constituting the target region;

FIG. 6 shows an example of a correction function table;

FIG. 7 is an example of a flowchart of image processing for generating a reproduced image that was color corrected;

FIG. 8 is an example of a flowchart of region segmentation processing by edge recognition;

FIG. 9 is an example of the flowchart of image correction processing; and

FIG. 10(a) is a schematic diagram for explaining the position of the pixel which is the correction target in the boundary region 10, (b) represents an example of a drawing illustrating the contribution ratio of the correction function of the two image object regions sandwiching the boundary region to the boundary region.

### DETAILED DESCRIPTION OF PREFERRED EMBODIMENTS

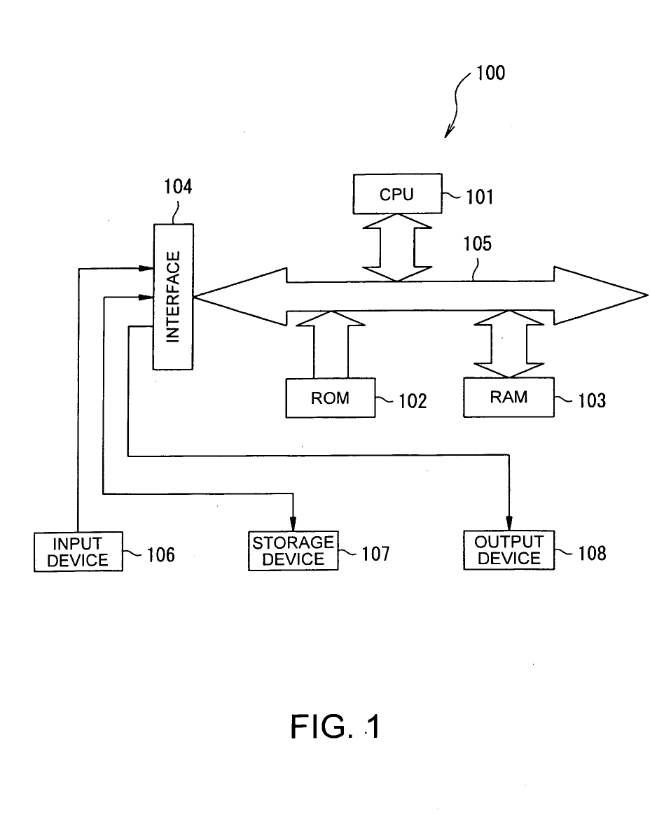

An embodiment of the present invention will be described hereinbelow with reference to the drawings. FIG. 1 is an exemplary structural diagram of an image processing device. As shown in FIG. 1, an image processing device 100 can include a CPU 101 controlling the operation and the entire device based on a control program, a ROM 102 in which, e.g., the control program of the CPU 101 is stored in advance in a prescribed area, a RAM 103 for storing the information read, e.g., from ROM 102 and the operation results necessary for the operation process of the CPU 101, and an interface 104 for input/output information to/from external devices. The aforesaid components can be connected to each other via a bus 105 which is a signal line for transferring information, this connection enabling the information exchange between the components.

An input device 106, such as a keyboard and a mouse which is capable of inputting data, a memory device 107 for storing image information of the image which is the object of image processing, and an output device 108 for outputting the results of image processing to a screen or the like are connected as external devices to the interface 104.

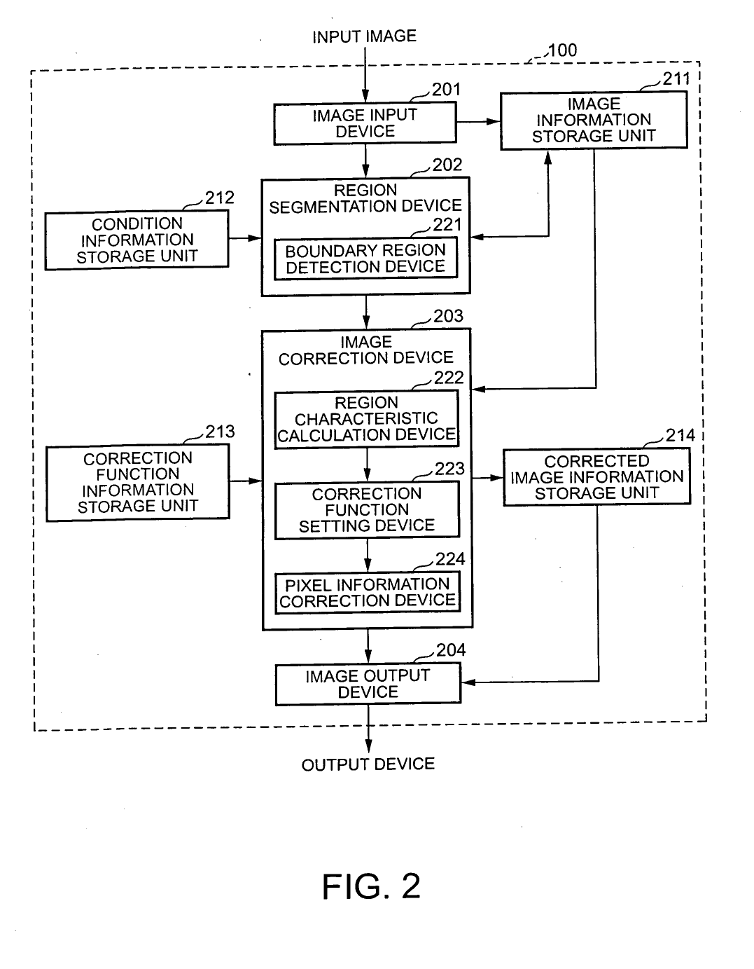

FIG. 2 is an example of the functional block diagram of the image processing device. As shown in FIG. 2, the image processing device 100 can include an image input device 201, a region segmentation device 202, an image correction device 203, and an image output device 204.

The image input device 201 inputs image information of the target image, acquires it as pixel information for each pixel constituting the target image, and stores in an image information storage unit 211. Furthermore, the inputted pixel information is converted into information in a data format adequate for image processing, and stored in the image information storage unit 211. For example, the information in an RGB bitmap format is converted into a data format based on a CIE L*a*b* color system and stored in the image information storage unit 211.

Digital image data acquired by a digital still camera or scanner is typically in an RGB bitmap format. Furthermore, digital image data for conducting output by printing or with a color printer is in a CMYK bitmap format. Here, in the present embodiment, image processing will be conducted by conversion to a bitmap format represented by values of hue, saturation, and lightness suitable for representing the difference in color and brightness in human vision. A CIE L*a*b* color system is a typical representation format for representing the difference in color perceived by human vision as a numerical value. In the image processing in accordance with the present invention, the image information is handled in the data format based on a CIE L*a*b* color system, but is not limited thereto. For example, in order to conduct processing by focusing attention on the hue or saturation, if the representation is conducted in a polar coordinate system on an a*b* plane with respect to the hue and saturation in a color space of the CIE L*a*b* color system, then the processing becomes simple. The explanation below will be conducted by considering as an example a bitmap format with representation by the hue, saturation, and lightness as the image information. Furthermore, the pixel characteristic is an information specifying a pixel in pixel information. In the present embodiment, it refers to the hue, saturation, and lightness.

The region segmentation device 202 extracts a boundary point between the adjacent pixels in which the characteristics of the two pixels differ significantly as an edge point for all the pixels constituting the target image, and when neighboring edge point groups constitute a closed space, this closed space is detected as an image object region. The condition the characteristics of the two pixels differ significantly is the edge recognition condition and is the information stored in a condition information storage unit 212.

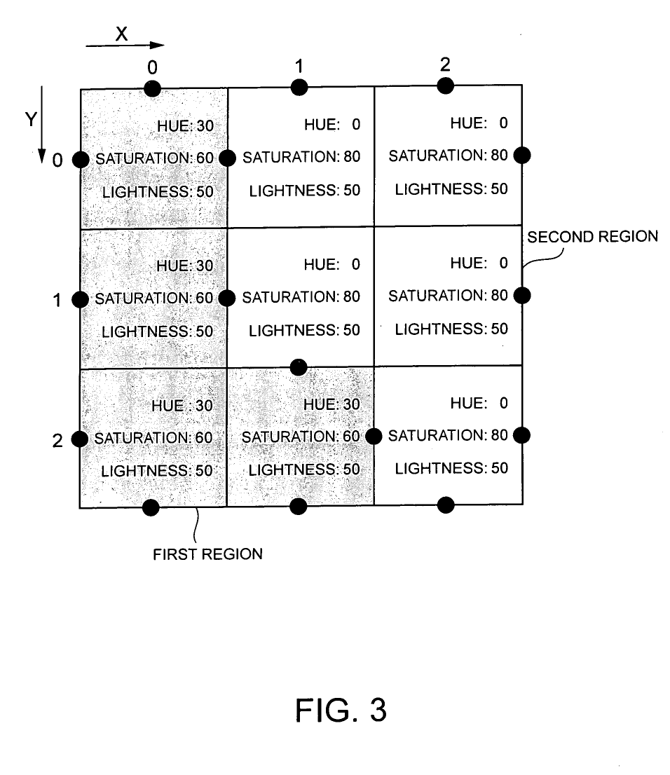

FIG. 3 is a schematic diagram illustrating a three row by three column pixel bitmap data. Here each pixel is also provided with a position information identified by the X coordinate and Y coordinate as image object information. Furthermore, a pixel is represented as p(x, y). As shown in FIG. 3, if boundary points are retrieved in which the characteristics of two pixels differ significantly between the two adjacent pixels, then the boundary points shown by black circles are detected. Here, the case in which the hue differs by 15 or more is considered as a boundary point was considered as an edge recognition condition. The closed space constituted by those black circles is detected as an image object region. Therefore, in FIG. 3, the target region is segmented into a first region which is an image object region constituted by pixels p(0, 0), p(0, 1), p(0, 2), p(1, 2) and a second region which is an image object region constituted by pixels p(1, 0), p(2, 0), p(1, 1), p(2, 1), p(2, 2).

Further, the region segmentation device 202 can be also provided with a boundary region detection device 221. The boundary region detection device 221 detects the image object region and boundary region from the target image. Thus, the region constituted by pixels having characteristics intermediate between those of respective image object at the boundary of two adjacent image objects and in the vicinity thereof is detected as a boundary region. More specifically, two adjacent image object regions are considered as respective first image object region and second image object region based on the prescribed region recognition condition and characteristics of a plurality of pixels arranged continuously in the prescribed direction from the attention pixel, and a first pixel group and second pixel group belonging to the first image object region and second image object region, respectively, and a boundary pixel group sandwiched between the first pixel group and second pixel group are detected. Identical pixel groups arranged continuously in this plurality of detected boundary image groups are detected as a boundary region.

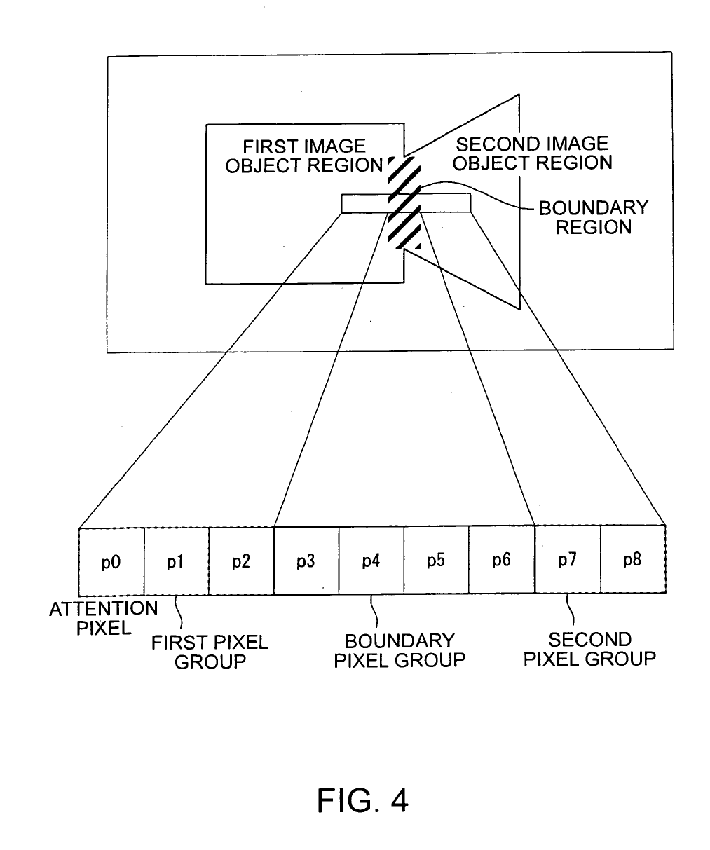

FIG. 4 is a schematic diagram for explaining the first pixel group, second pixel group, and boundary pixel group. Pixels pi arranged continuously in a prescribed direction (for example, X direction) from the attention pixel p0 are picked up successively and a decision is made as to whether the pixels pi that were picked up successively belong to the first pixel group, second pixel group, or boundary pixel group, based on the characteristics of the picked-up pixels pi and, if necessary, the characteristics from the pixel pj to the pixel pi and the prescribed region recognition conditions. The explanation below is conducted with respect to the case in which the region recognition conditions are the below-described three conditions.

(Condition 1) The first pixel group is a pixel group arranged continuously in a prescribed direction from the attention pixel, wherein the difference in characteristics between the adjacent pixels is less than a prescribed threshold A.

(Condition 2) The boundary pixel group is a pixel group arranged continuously in a prescribed direction from the first pixel group, wherein the difference in characteristics between the adjacent pixels is not less than a prescribed threshold A and the difference in changes of the characteristics is less than a prescribed threshold B.

(Condition 3) The second pixel group is a pixel group arranged continuously in a prescribed direction from the boundary pixel group, wherein the difference in characteristics between the adjacent pixels is less than a prescribed threshold A and the difference in the characteristics with the first pixel group is not less than a prescribed threshold C.

The difference ci in changes of characteristics is an absolute value of the difference between the difference in characteristics between the pixel pi−2 and pixel pi−1 and the difference in characteristics between the pixel pi−1 and pixel pi. If the characteristic of the picked-up pixel pi is denoted as characteristic ai, then the difference bi in characteristics between the adjacent pixels will be bi=ai−ai−1, and the difference ci in changes will be ci=|bi−bi−1|. Furthermore, the difference in characteristics between the first pixel group and pixel pi is an absolute value of the difference between a characteristic representing the first pixel group and the characteristic of pixel pi, and if the characteristic representing the first pixel group is denoted by a0, then the difference di in characteristics with the pixel pi will be di=|a0−ai|.

In FIG. 4, if the pixels are successively retrieved, the pixels satisfying the conditions (bi<A), which is Condition 1, are with i=0 to 2, the pixels satisfying the conditions {(bi>=A) and (bi+1>=A)}, (ci<B), and (present in the prescribed direction from the pixels satisfying Condition 1), which is Condition 2, are with i=3 to 6, and the pixels satisfying the conditions [{(bi>=A) and (bi+1<A)}, or (bi<A)] and (di>=C), and (present in the prescribed direction from the pixels satisfying Condition 2), which is Condition 3, are with i=7 to 8. Therefore, {p0, p1, p2} is detected as the first pixel group, {p3, p4, p5, p6} is detected as the boundary pixel group, and {p7, p8} is detected as the second pixel group.

A target region can be segmented into the image object region and boundary region and detected, by detecting the abovementioned pixel groups. The image object region and boundary region will be referred to hereinbelow as image regions.

The image correction device 203 calculates region characteristics illustrating representative characteristics of image regions with respect to the image regions segmented by a region segmentation device 202, sets a correction function for correcting pixel information serving as a correction target, based on the calculated region characteristics of the image regions, and corrects the color of the reproduced image with the correction function that was thus set. Furthermore, image correction means 203 can include a region characteristic calculation device 222, correction function setting device 223, and pixel information correction device 224.

The region characteristic calculation device 222 calculates the region characteristics of image regions for each image region based on the characteristics of pixels constituting the image region. For example, when the mean value of the characteristics of all the pixels belonging to the image region is the region characteristic of the image region, the region characteristic of the first region shown in FIG. 3 will be “hue: 30”, “saturation: 60”, “lightness: 50”, and the region characteristic of the second region will be “hue: 0”, “saturation: 80”, “lightness: 50”.

It should be understood that region characteristics of image regions are not limited to the mean value of the characteristics of all the pixels belonging to the image region, and dispersion, central value, maximum value, minimum value, and the like, can be also considered.

The correction function setting device 223 sets the correction function for correcting the pixel information of pixels with the object of bringing the color of the reproduced image close to the memorized color, based on the region characteristics of image regions and the prescribed application conditions. The correction function for correction from the original information of pixel information to the information after correction is in the form of formulas or tabular values, and the information after conversion may be uniquely determined by the original information. A table having a plurality of sets of the application conditions and correction functions will be called a correction function table.

The correction function table is set in advance and stored in correction function information storage unit 213. Further, a plurality of correction function tables can be prepared and used by switching. For example, correction function tables such as “person”, “scenery”, “natural”, “passionate”, and “cool” are prepared, and when the correction function table “person” is used, the saturation as a whole is reduced and correction to a soft color tone is conducted, and when the correction function table “passionate” is used, the correction is conducted so as to increase the intensity of red-related colors. Switching of the correction function tables can be conducted for each image region in the target image and for each target image.

The pixel information correction device 224 corrects the characteristics of all the pixels constituting the image region with the correction function set with the correction function setting means 223. Thus, pixel information of the pixels constituting the corrected image which is the image after the correction is calculated anew. The calculated pixel information is stored in the corrected image information storage unit 214.

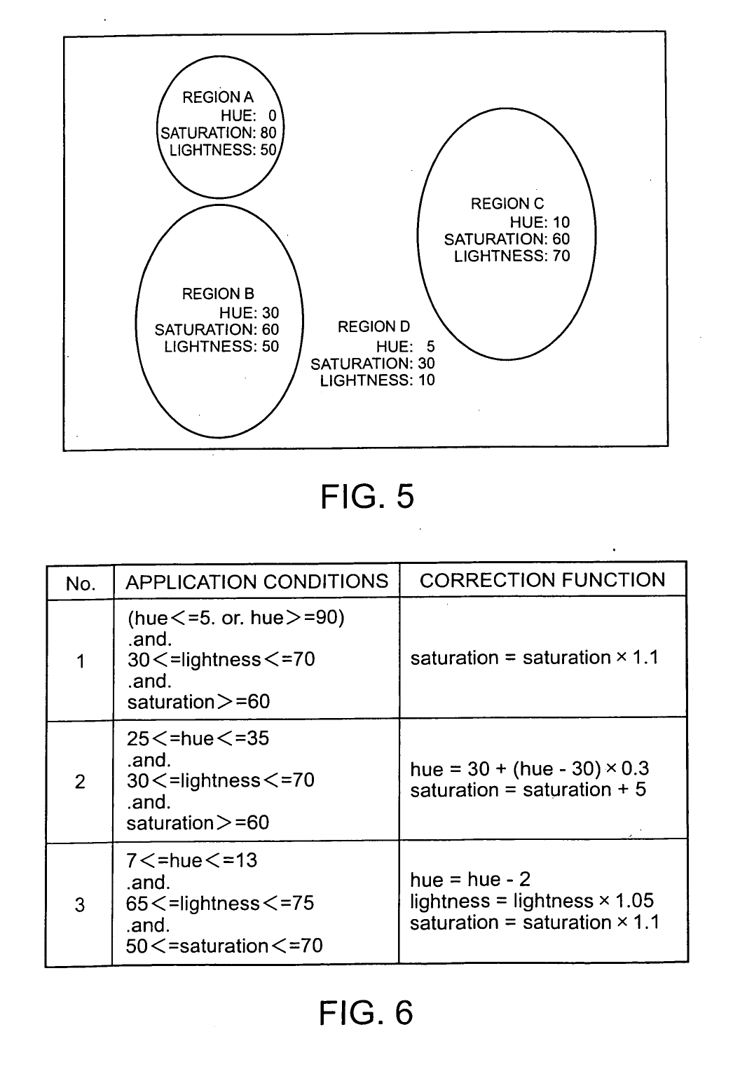

FIG. 5 is a schematic drawing illustrating region characteristics of image regions constituting the target region. FIG. 6 shows an example of a correction function table.

As shown in FIG. 5, the target region is composed of four image regions. Mean values of characteristics of all the pixels constituting the image region are set as region characteristics of respective image regions. It is clear that if the region characteristics of region A are applied to the application conditions of the correction function table shown in FIG. 6, they will fit the condition No. 1. Thus, “saturation=saturation×1.1” is set as the correction function, and the “saturation” of all the pixels belonging to the region A are newly calculated based on this correction function. Further, it is clear that if the region characteristics of region B are applied to the application conditions of the correction function table shown in FIG. 6, they will fit the condition No. 2. Thus, “hue=30+(hue−30)×0.3” and “saturation=saturation+5” are set as the correction function, and the “hue” and “saturation” of all the pixels belonging to the region B are newly calculated based on this correction function.

Further, it is clear that if the region characteristics of region C are applied to the application conditions of the correction function table shown in FIG. 6, they will fit the condition No. 3. Thus, “hue=hue−2”, “lightness=lightness×1.05” and “saturation=saturation×1.1” are set as the correction function, and the “hue”, “lightness” and “saturation” of all the pixels belonging to the region C are newly calculated based on this correction function. Further, it is clear that if the region characteristics of region D are applied to the application conditions of the correction function table shown in FIG. 6, there are no fitting conditions. Thus, pixel information of all the pixels belonging to the region D remains the pixel information acquired by image input means 201.

Therefore, the image obtained by correcting the target image shown in FIG. 5 based on the correction function table shown in FIG. 6 is a corrected image in which “the saturation of region A is increased”, “the hue of region B is brought close to the intermediate color of region B and the saturation is uniformly increased”, and “the hue of region C is slightly changed and the lightness and saturation are increased and became brighter”.

The image output device 204 acquires from the corrected image information storage unit 214 the image information of the corrected image that was corrected from the original image with the image correction means 203 and converts the acquired image information into the desired data format and outputs it. For example, when the information stored in the corrected image information storage unit 214 is in a data format based on the CIE L*a*b* color system and the desired data format is an RGB bitmap format, the image information is outputted upon conversion from a data format based on the CIE L*a*b* color system into the RGB bitmap format.

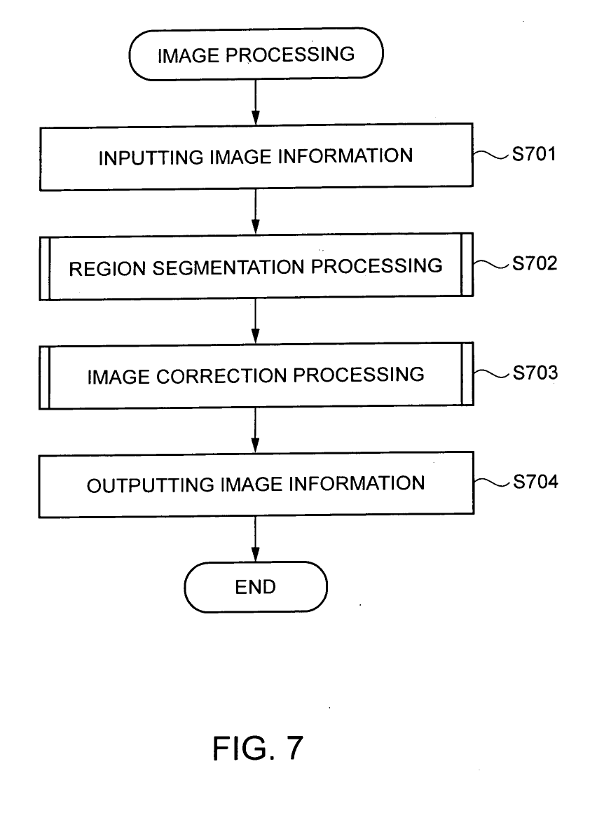

FIG. 7 is an example of a flowchart of image processing for generating a reproduced image that was color corrected according to a control program that was stored in advance in ROM 102.

First, image information of a target image is inputted and the inputted image information is converted into a data format adequate for image processing and stored in the image information storage unit 211 (S701). Then, the target image is segmented into a plurality of image regions and detected based on the acquired image information of the target image and the region segmentation condition information that was stored in advance in the condition information storage unit 212 (S702). Here, the image regions which are segmented are obtained by edge recognition as image object regions and background regions, but as explained in FIG. 4, the boundary regions can be also detected as the image regions by executing the processing of detecting the boundary regions. The region segmentation processing by edge recognition will be described below in greater detail.

A region characteristic of the image region is then computed for each segmented image region, a correction function is set based on the calculated characteristic of the image region, the image information is corrected based on the correction function that was set, and the image information that was corrected is stored in the corrected image information storage unit 214 (S703). The image correction processing will be described below in greater detail. Finally, the image information of the corrected image that was corrected from the inputted original image is acquired from the corrected image information storage unit 214 and the acquired image information is converted into the desired data format and outputted (S704).

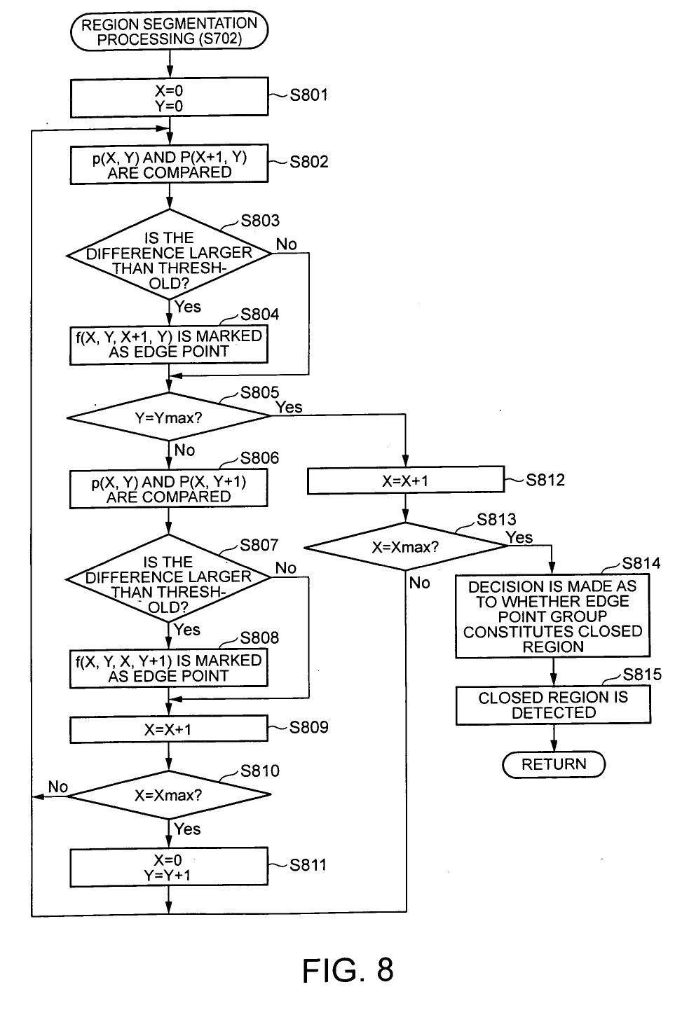

FIG. 8 is an example of a flowchart of region segmentation processing by edge recognition shown in FIG. 7. The flowchart shown in FIG. 8 will be described below with reference to the case shown in FIG. 3 as an example. Each pixel is provided with position information identified by the X coordinate and Y coordinate as image information. Further, a pixel is denoted by p(x, y). In FIG. 8, the central point of the boundary portion between the adjacent pixels is called a boundary point and denoted by f(x1, y1, x2, y2). The boundary point f(x1, y1, x2, y2) is a central point of a boundary portion of the pixel p(x1, y1) and pixel p(x2, y2).

First we will pay attention to pixel p(0, 0) (S801) and compare the characteristics of pixel p(0, 0) and pixel P(1, 0) (S802). In this process, the pixel p(0, 0) to which the attention should be paid is called an attention pixel, and the pixel P(1, 0) which is to be compared is called a comparison pixel. As a result, when the difference in characteristics between the pixel p(0, 0) and pixel P(1, 0) is larger than the preset edge recognition threshold (S803; Yes), the boundary point f(0, 0, 1, 0) is decided to be an edge point (S804).

For example, if a “hue value: 15” is set as the edge recognition threshold, because the difference between the hue value (=30) of the pixel p(0, 0) and the hue value (=0) of the pixel P(1, 0) is larger than the edge recognition threshold, the boundary point f(0, 0, 1, 0) is decided to be an edge point. Here, any one of the hue, saturation, and lightness or combinations of several of them can be set as the threshold. Furthermore, an overall color difference such as a AE value based on the CIE L*a*b* color model can be also used. The threshold is set in advance and stored in the condition information storage unit 212.

Characteristics of the pixel p (0, 0) and pixel P(0, 1) are then compared (S806). When the difference in characteristics between the pixel p(0, 0) and pixel P(0, 1) is larger than the preset edge recognition threshold (S807; Yes), the boundary point f(0, 0, 0, 1) is decided to be an edge point (S808). Because the difference between the hue value (=30) of the pixel p(0, 0) and the hue value (=30) of the pixel P(0, 1) is not larger than the edge recognition threshold, the boundary point f(0, 0, 0, 1) is not considered as an edge point.

The attention pixel is then moved to pixel p(1, 0) (S809, S811, or S812), the pixel p(1, 0) and pixel P(2, 0) are similarly compared and an edge point is detected. The detection of edge points is thus executed for all the pixels constituting the target image, by moving the attention pixel (S805, S810, or S813). Therefore, as shown in FIG. 3, the boundary points shown by black circles are detected as edge points.

Then, a decision is made as to whether the adjacent edge point groups constitute a closed region (S814). In the case shown in FIG. 3, the regions composed of edge point groups located within a distance 1 are detected as a closed region (S815). Therefore, the first region which is the closed region composed of pixels p(0, 0), p(0, 1), p(0, 2), p(1, 2) and the second region which is the closed region composed of pixels p(1, 0), p(2, 0), p(1, 1), p(2, 1), p(2, 2) are detected.

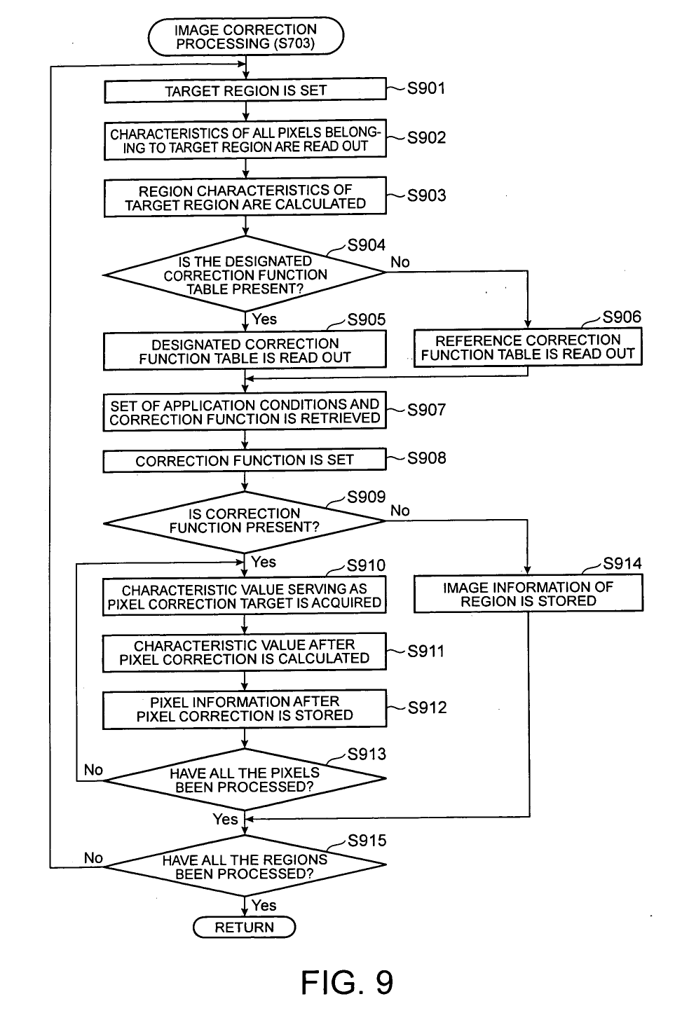

FIG. 9 is an example of the flowchart of image correction processing in FIG. 7. FIG. 9 will be described by considering the case illustrated by FIG. 5 and FIG. 6 as an example.

First, a target region for correcting the image information is set (S901). Then, pixel information of all the pixels constituting the target region is read out from the image information storage unit 211 (S902) and the region characteristics of the target region is calculated (S903). For example, in FIG. 5, when the target region is set as region A, “hue: 0”, “saturation: 80”, and “lightness: 50” are calculated as the region characteristics of region A.

Then, a decision is made as to whether a designated correction function table is present with respect to the target region (S904). If the designated correction function table is present (S904; Yes), the designated correction function table is read from the correction function information storage unit 213 (S905) and the processing flow advances to the next step S907. For example, when a “person” correction function table has been designated with respect to the target region, the “person” correction function table is read from the correction function information storage unit 213. On the other hand, when a designated correction function table is not present (S904; No), the reference correction function table that was set in advance is read from the correction function information storage unit 213 (S906) and the processing flow advances to the next step S907.

Then, a set of application conditions and correction function for which the region characteristics of the target region calculated in step S903 are satisfied is retrieved from the correction function table based on the application conditions of the acquired correction function table (S907) and a correction function is set (S908). For example, in the case of region A, it is retrieved that the set for which the region characteristics of region A satisfy the application conditions of the correction function table shown in FIG. 6 is set No. 1. Therefore, “saturation=saturation×1.1” is set as the correction function.

Then, a decision is made as to whether the application conditions satisfying the region characteristics are present (S909). When there are no application conditions satisfying the region characteristics (S909; No), the pixel information of all the pixels of the target region is stored without correction in the corrected image information storage unit 214 (S914), and the processing flow advances to the next step S915. In FIG. 5, in region D, there are no application conditions satisfying the region characteristics. Therefore, image information of region D remains the original image. On the other hand, when there are application conditions satisfying the region characteristics (S909; Yes), pixel information of the pixels which are the target of correction is acquired (S910), the corrected values of the acquired pixel information is calculated based on the correction function (S911), and the calculated corrected values and other pixel information are stored in the corrected image information storage unit 214 (S912). For example, in the case of region A, the saturation of pixels is acquired, the saturation after correction is calculated with the correction function “saturation=saturation×1.1”, and the corrected saturation and non-corrected hue and lightness are stored in the corrected image information storage unit 214.

A decision is then made as to whether the corrected values of pixel information of the correction target have been calculated for all the pixels of the target region (S913). When the corrected values of pixel information of the correction target have been calculated for all the pixels (S913: Yes), the processing flow advances to the next step S914. When the corrected values of pixel information of the correction target have not been calculated for all the pixels (S913: No), the steps from step S910 to step S912 are repeated till the corrected values of pixel information of the correction target are calculated for all the pixels.

Finally, a decision is made as to whether the correction processing has been executed for all the image regions of the target image as the target regions (S915). When the correction processing has not been executed for all the image regions as the target regions (S915; No), the steps from step S901 to step S914 are repeated till the correction processing is executed for all the image regions as the target regions. On the other hand, when the correction processing has been executed for all the image regions as the target regions (S915; Yes), the processing is ended. For example, in FIG. 5, the steps from step S901 to step S914 are executed with respect to each region of region A, region B, region C, and region D.

The above-described image correction relates to the case of selecting an image object region as a target and referring to a correction function table, but the explanation will be also provided with respect to image correction in a boundary region detected by the method such as described with reference to FIG. 4.

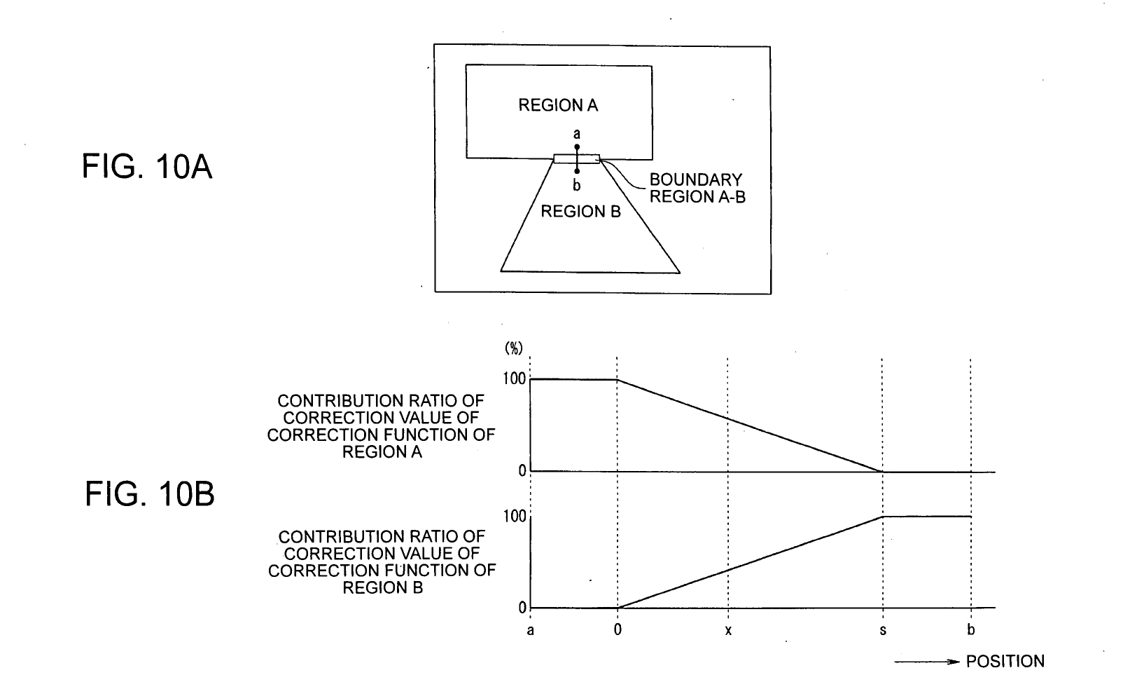

FIG. 10(a) is a schematic diagram for explaining the position of the pixel which is the correction target in the boundary region. FIG. 10(b) represents an example of a drawing illustrating the contribution ratio of the correction function of the two image object regions sandwiching the boundary region to the boundary region.

FIG. 10(b) shows the ratio (referred to hereinbelow as a contribution ratio) of a contribution made to the characteristic value c after the correction by the correction value ca=fa(c0) calculated with the correction function fa of region A and the correction value cb=fb(c0) calculated with the correction function fb of region B with respect to the pixels of the boundary region present on the a-b line in FIG. 10(a). Thus, in the region A, the contribution ratio of ca is 100(%), and the contribution ratio of cb is 0(%). In the region B, the contribution ratio of ca is 0(%), and the contribution ratio of cb is 100(%). With respect to the pixels present in the boundary region sandwiched by the region A and region B, the contribution ratio of ca is 100×(s−x)/s(%), and the contribution ratio of cb is 100×x/s(%). Here, c0 represents the characteristic value prior to correction, x represents the position of pixels, and s represents the width of the boundary region. Therefore, the characteristic value (c) after the correction of pixels in the boundary region sandwiched by the region A and region B can be represented by the correction value ca calculated with the correction function fa of region A, the correction value cb calculated with the correction function fb of region B, and the position of the pixel, by the following formula.

c={ca×(s−x)+cb×x}/s

As described hereinabove, an image can be also corrected in the boundary region by setting a correction function of pixel information of the correction target in the boundary region. Furthermore, in FIG. 10(b), the respective contribution ratios of the region A and region B to the boundary region are represented as linear equations, but the contribution ratios can be also determined by the pixel information of the pixels of the boundary region. For example, the contribution ratios can be also determined proportionally to the variation quantity from the characteristic value of region A to the characteristic value of the pixel which is the correction target and to the variation quantity from the characteristic value of the pixel which is the correction target to the characteristic value of region B.

Further, regarding the execution of processing shown in the aforementioned flowcharts of FIGS. 7, 8, and 9, the explanation was conducted with respect to the case of executing a control program that has been stored in advance in the ROM 102, but a program may be also executed by reading to the RAM 103 from an information storage medium where the program for executing each of those steps was recorded.

Here, the information storage medium can include all the information storage media, provided they are computer-readable information storage media, regardless of the type of reading method, i.e., electronic, magnetic, or optical, and may be a semiconductor storage medium such as RAM and ROM, a storage medium of a magnetic recording such as FD and HD, a storage medium of optical reading such as CD, CDV, LD, and DVD, and a storage medium using magnetic recording and optical reading, such as MO.

The above-described preferred embodiments are for explanation purposes and place no limitation on the scope of the present invention. Therefore, a person skilled in the art can employ the embodiments in which each of the elements or all the elements are replaced with equivalents thereof, and those embodiments are also included in the scope of the present invention.

What is claimed is:

1. An image processing device, comprising:
a region segmentation device that segments a target image composed of a plurality of pixels into a plurality of image object regions by employing as boundaries portions where characteristics between the pixels change; and
an image correction device that corrects the pixel information of the pixels constituting the image object region based on region characteristic information indicating a representative characteristic of the image object region, for each of the image object region segmented by the region segmentation device.

2. An image processing device, comprising:
a region segmentation device that segments a target image composed of a plurality of pixels into a plurality of image object regions; and
an image correction device that corrects the pixel information of the pixels constituting the image object region based on region characteristic information indicating a characteristic of the image object region, for each of the image object region segmented by the region segmentation device.

3. The image processing device according to claim 1, the image correction device further comprising:
a region characteristic calculation device that calculates the region characteristic information of the image object region based on the pixel information of the pixels constituting the image object region;
a correction function setting device that sets a correction function for correcting the pixel information of the pixels constituting the image object region based on the region characteristic information of the image object region calculated by the region characteristic calculation device; and
a pixel information correction device that corrects the pixel information of the pixels constituting the image object region based on the correction function that was set by the correction function setting device.

4. The image processing device according to claim 1, comprising:
a region characteristic calculation device that calculates the region characteristic information of the image object region based on the pixel information of the pixels constituting the image object region; and
a correction function setting device that sets a correction function for correcting the pixel information of the pixels constituting the image object region based on the region characteristic information of the image object region calculated by the region characteristic calculation device,
the pixel information correction device including a pixel information correction device that corrects the pixel information of the pixels constituting the image object region based on the correction function that was set by the correction function setting device.

5. The image processing device according to claim 3,
the correction function setting device mapping the correction function with application conditions that define a plurality of the region characteristic information conditions retrieving the correction function corresponding to the application conditions that are satisfied by the region characteristic information from the plurality of correction functions based on the region characteristic information of the image object region.

6. The image processing device according to claim 5, the correction function setting device retrieving the application conditions that satisfy the region characteristic information of the image object region based on a correction function table comprising a plurality of sets of the application conditions and the correction functions and retrieves the correction function constituting the set with the retrieved application conditions.

7. The image processing device according to claim 5, the correction function setting device retrieving the application conditions to which the region characteristic information of the image object region corresponds, based on a correction function table that maps and registers a plurality of application conditions and correction functions, and retrieves the correction function corresponding to the retrieved application conditions.

8. The image processing device according to claim 6, the correction function setting device setting any one of the correction function table of a plurality of the different correction function tables with respect to one or a plurality of the image object regions and setting the correction function for correcting the pixel information of the pixels constituting the image object region based on the region characteristic information of the image object region and the correction function table that was thus set.

9. The image processing device according to claim 6, the correction function setting device setting any one of the correction function table of a plurality of the different correction function tables with respect to one or a plurality of the image object regions and setting the correction function that corrects the pixel information of the pixels constituting the image object region based on the region characteristic information of the image object region and the correction function table that was thus set.

10. The image processing device according to claim 1, the region segmentation device including a boundary region detection device that detects, based on prescribed region recognition conditions, as a boundary region, the pixel group which is the pixel group present on a boundary of the two adjacent image object regions and in the vicinity thereof and is composed of the pixels having characteristics intermediate between the respective characteristics of the two image object regions.

11. The image processing device according to claim 1, the region segmentation device including a boundary region detection device that detects, based on prescribed region recognition conditions, as a boundary region of a first image object region and a second image object region, a boundary pixel group sandwiched by a first pixel group composed of pixels having characteristics of the first image object region and a second pixel group composed of pixels having characteristics of the second image object region, where one of the image object region of an adjacent image object region is considered as the first image object region and the other image object region is considered as the second image object region.

12. The image processing device according to claim 10, the correction function setting device correcting the pixel information of the pixels constituting the boundary region based on a first correction function which is the correction function set by the region characteristic information of the first image object region and a second correction function which is the correction function set by the region characteristic information of the second image object region, where the first image object region and second image object region are the two image object regions sandwiching the boundary region.

13. An image processing method, comprising:
a region segmentation step of segmenting a target image composed of a plurality of pixels into a plurality of image object regions by employing as boundaries portions where characteristics between the pixels change; and
an image correction step of correcting the pixel information of the pixels constituting the image object region based on region characteristic information indicating a representative characteristic of the image object region, for each of the image object region segmented in the region segmentation step.

14. The image processing method according to claim 13, the image correction step, further comprising:
a region characteristic calculation step of calculating the region characteristic information of the image object region based on the pixel information of the pixels constituting the image object region;
a correction function setting step of setting a correction function that corrects the pixel information of the pixels constituting the image object region based on the region characteristic information of the image object region calculated in the region characteristic calculation step; and
a pixel information correction step of correcting the pixel information of the pixels constituting the image object region based on the correction function that was set in the correction function setting step.

15. The image processing method according to claim 13, the region segmentation step, further comprises:
a boundary region detection step of detecting, based on prescribed region recognition conditions, as a boundary region, the pixel group which is the pixel group present on the boundary of the two adjacent image object regions and in a vicinity thereof and is composed of the pixels having characteristics intermediate between the respective characteristics of the two image object regions.

16. A program for executing with a computer each of the following steps of an image processing method:
a region segmentation step of segmenting a target image composed of a plurality of pixels into a plurality of image object regions by employing as boundaries portions where characteristics between the pixels change; and
an image correction step of correcting the pixel information of the pixels constituting the image object region based on region characteristic information indicating a representative characteristic of the image object region, for each of the image object region segmented in the region segmentation step.

17. The program according to claim 16 for executing with a computer each of the following steps comprised in the image correction step of an image processing method:
a region characteristic calculation step of calculating the region characteristic information of the image object region based on the pixel information of the pixels constituting the image object region;
a correction function setting step of setting a correction function for correcting the pixel information of the pixels constituting the image object region based on the region characteristic information of the image object region calculated in the region characteristic calculation step; and
a pixel information correction step of correcting the pixel information of the pixels constituting the image object region based on the correction function that was set in the correction function setting step.

18. The program according to claim 16 for executing with a computer the following step comprised in the region segmentation step of an image processing method:
a boundary region detection step of detecting, based on prescribed region recognition conditions, as a boundary region, the pixel group which is the pixel group present on the boundary of the two adjacent image object regions and in the vicinity thereof and is composed of the pixels having characteristics intermediate between the respective characteristics of the two image object regions.
